(19) United States
(12) Patent Application Publication
(10) Pub. No.: US 2012/0154383 A1
(43) Pub. Date: Jun. 21, 2012

(54) IMAGE PROCESSING APPARATUS AND IMAGE PROCESSING METHOD

(75) Inventors: Nobuyuki Ikeda, Fuchu-shi (JP); Tamotsu Hasegawa, Tokyo (JP); Tatsuhiro Nishioka, Kawasaki-shi (JP)

(73) Assignee: KABUSHIKI KAISHA TOSHIBA, Tokyo (JP)

(21) Appl. No.: 13/272,053

(22) Filed: Oct. 12, 2011

(30) Foreign Application Priority Data
Dec. 21, 2010 (JP) 2010-284751

(51) Int. Cl. G06T 15/00

(52) U.S. Cl. 345/419

(57) ABSTRACT

According to one embodiment, an image processing apparatus includes a first generation module, a second generation module, and processor. The first generation module is configured to generate 3D image data. The second generation module is configured to generate 3D graphics data. The processor is configured to make the 3D image data fall within a first display range which has a first depth range in a depth direction, and makes the 3D graphics data fall within a second display range which has a second depth range which does not overlap the first display range in the depth direction.

### CROSS-REFERENCE TO RELATED APPLICATIONS

This application is based upon and claims the benefit of priority from prior Japanese Patent Application No. 2010-284751, filed Dec. 21, 2010, the entire contents of which are incorporated herein by reference.

### FIELD

Embodiments described herein relate generally to an apparatus and a method which perform image processing.

### BACKGROUND

Three-dimensional image display techniques of various methods have been developed at present. An example of the techniques is a three-dimensional image display technique using spectacles. The user can cognize a three-dimensional image, by viewing a right-eye image and a left-eye image which are displayed on an image display apparatus with special spectacles.

Another example of the techniques is a technique of a naked-eye type. The user can cognize a three-dimensional image, by viewing a plurality of parallactic images, which are obtained at viewpoints shifted in the left and right directions and displayed on an image display apparatus, without using special spectacles. Generally, three-dimensional image display techniques of the naked eye type adopt a both-eyes parallax method using parallax between both eyes.

A three-dimensional image is formed of a three-dimensional image based on 3D image data obtained by processing contents obtained from broadcasting waves. In some cases, a three-dimensional image is obtained by superposing, on 3D image data, a three-dimensional image based on 3D graphics data obtained by processing graphics such as a telop and a banner obtained from broadcasting waves, a menu (a setting picture such as volume setting and brightness setting, and an EPG (electronic program guide) picture) based on user's selection, and alert. When the depth of the 3D image data overlaps the depth of the 3D graphics data, the three-dimensional image is cognized by the user as unnatural. The term “depth” means a position of a three-dimensional image in the depth direction from the front, in the maximum display range of the depth direction of the three-dimensional image.

For example, when the 3D graphics data is opaque (α=1), the 3D graphics data cuts into the 3D image data. Specifically, in a part in which the 3D graphics data is superposed on the 3D image data, the user cognizes that the 3D graphics data pushes the 3D image data into the depth of the 3D graphics data.

In addition, when the 3D graphics data is transparent (0≦α<1), the 3D graphics data is embedded in the 3D image data. Specifically, in a part in which the 3D graphics data is superposed on the 3D image data, the user cognizes that the 3D image data projects forward from the 3D graphics data. Therefore, when the 3D graphics data is an EPG or the like and includes characters, the user may cognize that the 3D graphics data is difficult to read by influence of the 3D image data.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary schematic diagram illustrating a three-dimensional image display apparatus according to an embodiment.

FIG. 2 is an exemplary diagram illustrating an example of a whole structure of a television reception apparatus united with the three-dimensional image display apparatus according to the embodiment.

FIG. 3 is an exemplary schematic diagram illustrating a maximum display range of a three-dimensional image according to the embodiment.

FIG. 4 is an exemplary block diagram illustrating a structure of a 3D processor according to the embodiment.

FIG. 5 is an exemplary diagram illustrating an image depth table according to the embodiment.

FIG. 6 is an exemplary diagram illustrating a graphics depth table according to the embodiment.

FIG. 7 is an exemplary schematic diagram illustrating a state in which 3D graphics data is superposed on 3D image data according to the embodiment.

FIG. 8 is an exemplary schematic diagram illustrating a state in which 3D graphics data is superposed on 3D image data according to the embodiment.

### DETAILED DESCRIPTION

Various embodiments will be described hereinafter with reference to the accompanying drawings.

In general, according to one embodiment, an image processing apparatus includes a first generation module, a second generation module, and processor. The first generation module is configured to generate 3D image data. The second generation module is configured to generate 3D graphics data. The processor is configured to make the 3D image data fall within a first display range which has a first depth range in a depth direction, and makes the 3D graphics data fall within a second display range which has a second depth range which does not overlap the first display range in the depth direction.

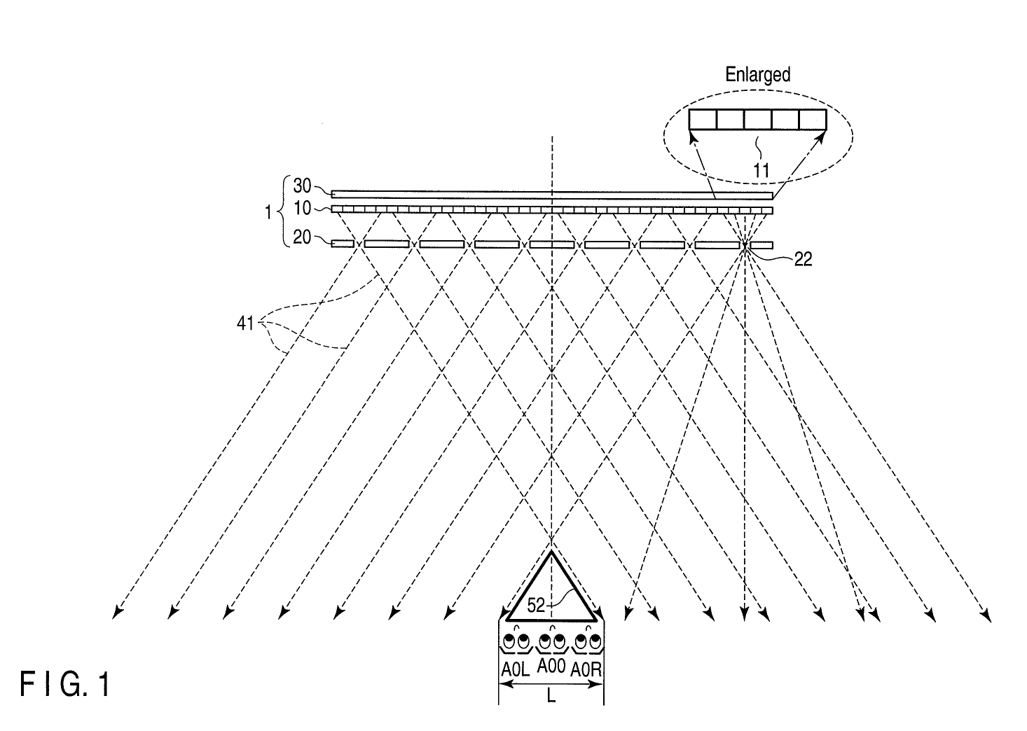

Embodiments will be described hereinafter with reference to drawings. First, the principle of three-dimensional display will be explained hereinafter. FIG. 1 is a cross-sectional view which schematically illustrates an example of an image display apparatus according to an embodiment. Although the embodiment shows an example of a three-dimensional image display technique of an integral method, the method of three-dimensional display may be the naked-eye method or the spectacle method other than the integral method.

A three-dimensional image display apparatus 1 illustrated in FIG. 1 comprises a display unit 10 which has a number of three-dimensional image display pixels 11 that are arranged in rows and columns, and a mask 20 which is provided with a number of window parts 22 that are positioned apart from the pixels 11 and correspond to the pixels 11.

The mask 20 includes optical openings, and has a function of controlling light beams from the pixels. The mask 20 is also referred to as a parallactic barrier or light-beam controlling element. As the mask 20, it is possible to use a structure in which a light-shield pattern which includes a number of openings corresponding to a number of window parts 22 is formed on a transparent board, or a light-shield board provided with a number of through holes corresponding to a number of window parts 22. As another example of the mask 20, it is possible to use a fly-eye lens which is formed by arranging a number of minute lenses in a two-dimensional manner, or a lenticular lens which includes optical openings that extend in a straight line in a vertical direction and are periodically arranged in a horizontal direction. In addition, as the mask 20, it is possible to use a structure in which the arrangement, size, and/or shape of the window parts 22 can be changed, such as a transmission liquid crystal display unit.

To view a moving image as a three-dimensional image, three-dimensional display pixels 11 are realized by using a liquid crystal display unit. A number of pixels of the transmission liquid crystal display unit 10 form a number of three-dimensional display pixels 10, and a backlight 30 which is a surface light source is arranged on the back side of the liquid crystal display unit 10. The mask 20 is arranged on the front side of the liquid crystal display unit 10.

In the case of using the liquid crystal display unit 10 of a transmission type, the mask 20 may be disposed between the backlight 30 and the liquid crystal display unit 10. Instead of the liquid crystal display unit 10 and the backlight 30, it is possible to use a self-light-emitting display apparatus, such as an organic EL (electroluminescence) display apparatus and a plasma display apparatus. In such a case, the mask 20 is disposed on the front side of the self-light-emitting display apparatus.

FIG. 1 schematically illustrates relation between the three-dimensional display apparatus 1 and observing positions A00, A0R, and A0L. The observing positions are positions obtained by moving in parallel with the horizontal direction of the display screen, with the distance from the screen (or the mask) fixed. This example shows a case one three-dimensional image display pixel 11 is formed of a plurality of (for example, five) two-dimensional display pixels. The number of pixels is an example, and may be smaller (for example, two) or larger (for example, nine) than five.

In FIG. 1, broken lines 41 are straight lines (light beams) each of which connects the pixel center located in the boundary between adjacent three-dimensional display pixels 11 with a window part 22 of the mask 20. In FIG. 1, an area enclosed by bold lines 52 is an area in which a true three-dimensional image (original three-dimensional image) is cognized. The observing positions A00, A0R, and A0L fall within the area of the bold lines 52. The observing position in which only a true three-dimensional image is observed is referred to as “viewing area”.

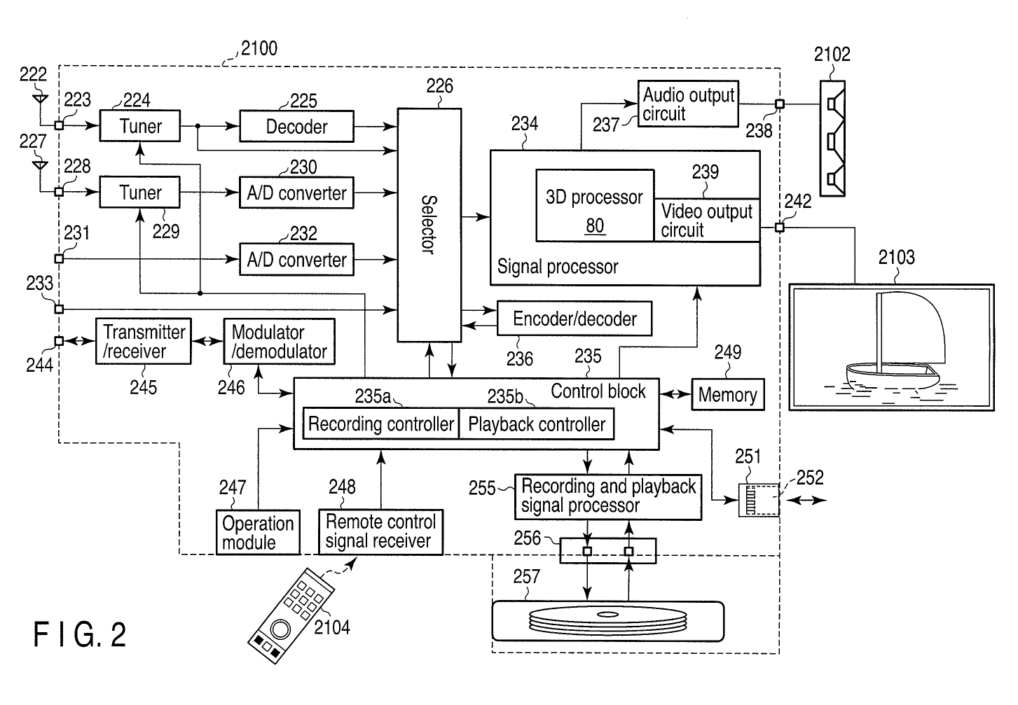

FIG. 2 schematically illustrates a signal processing system of a television broadcasting apparatus 2100, which is an example of an apparatus to which the three-dimensional display apparatus 1 is applied. A digital television broadcasting signal which is received by a digital television broadcasting receiving antenna 222 is supplied to a tuner 224 through an input terminal 223. The tuner 224 selects and demodulates a signal of a desired channel from the input digital television broadcasting signal. A signal outputted from the tuner 224 is supplied to a decoder 225, subjected to MPEG (moving picture experts group)-2 decoding, and then supplied to a selector 226.

In addition, the output of the tuner 224 is directly supplied to the selector 226. Image and sound data is separated from the signal. The image and sound data is processed by a recording and playback signal processor 255 through a controller 235, and can be recorded on a hard disk drive (HDD) 257. The HDD 257 is connected as a unit to the recording and playback processor 255 through a terminal 256, and can be exchanged for another HDD. The HDD 257 includes a signal recorder and a signal reader.

An analog television broadcasting signal which is received by an analog television broadcasting receiving antenna 227 is supplied to a tuner 229 through an input terminal 228. The tuner 229 selects and demodulates a signal of a desired channel from the input analog television broadcasting signal. A signal outputted from the tuner 229 is digitized by an A/D (analog/digital) converter 230, and thereafter outputted to the selector 226.

In addition, an analog image and sound signal which is supplied to an analog signal input terminal 231, to which an apparatus such as a VTR is connected, is supplied to an A/D converter 232 and digitized, and thereafter outputted to the selector 226. A digital image and sound signal which is supplied to a digital signal input terminal 233, to which an external apparatus such as an optical disk and a magnetic recording medium playback apparatus is connected through an HDMI (High Definition Multimedia Interface) 261 or the like, is directly supplied to the selector 226.

When the A/D converted signal is recorded on the HDD 257, the signal is subjected to compression by a predetermined format, such as MPEG (moving picture experts group)-2, by an encoder in an encoder/decoder 236 which accompanies the selector 226, and thereafter recorded on the HDD 257 through the recording and playback signal processor 255. When the recording and playback signal processor 255 records information on the HDD 257 by cooperating with a recording controller 235a, recording and playback signal processor 255 is programmed in advance to determine what information is recorded on which directory of the HDD 257. Therefore, conditions for storing a stream file in a stream directory, and conditions for storing identification information in a recording list file are set in the recording and playback signal processor 255.

The selector 226 selects one signal from the four input digital image and sound signals, and supplies the selected signal to a signal processor 234. The signal processor 234 separates image data and sound data from the input digital image and sound signal, and subjects the data to predetermined signal processing. As signal processing, the sound data is subjected to audio decoding, sound quality control, and mixing as desired. The image data is subjected to color and brightness separation, color control, and image quality control and the like. In addition, the signal processor 234 separates graphics data from the image and sound signal, and subjects the graphics data to predetermined signal processing. The signal processor 234 also receives graphics data (for example, a menu based on user input) from a control block 235.

The signal processor 234 superposes graphics data on image data, if necessary. The signal processor 234 also includes a 3D processor 80. The 3D processor 80 generates a three-dimensional image. The structure of the 3D processor 80 will be described later. A video output circuit 239 controls to display a plurality of parallactic images based on the image data (on which graphics data is superposed, if necessary) on a display apparatus 2103. The video output circuit 239 functions as display controller for parallactic images.

The image data (also graphics data, if necessary) is outputted to the display apparatus 2103 through an output terminal 242. As the display apparatus 2103, for example, the apparatus explained in FIG. 1 is adopted. The display apparatus 2103 can display both plane images (2D) and three-dimensional images (3D). Although a three-dimensional image is cognized by the user by viewing a plurality of parallactic images displayed on the display apparatus 2103, the present embodiment is explained on the assumption that the 3D processor 80 generates a pseudo-three-dimensional image with a depth, and the display apparatus 2103 displays a pseudo-three-dimensional image with a depth.

The sound data is converted to analog data by an audio output circuit 237, subjected to volume control and channel balance control and the like, and outputted to a speaker device 2102 through an output terminal 238.

Various operations including various receiving operations of the television broadcasting receiving apparatus 2100 are controlled by a control block 235. The control block 235 is an assembly of microprocessors including a CPU (central processing unit) and the like. The control block 235 obtains operation information from an operation module 247 or operation information transmitted from a remote controller 2104 through a remote control signal receiver 248, and controls blocks in the apparatus to reflect the operation contents.

The control block 235 uses a memory 249. The memory 249 mainly includes a ROM (read only memory) which stores a control program executed by the CPU, a RAM (random access memory) to provide the CPU with a work area, and a nonvolatile memory which stores various setting information items and control information.

The apparatus can communicate with an external server through the Internet. A downstream signal from a connecting terminal 244 is demodulated by a transmitter/receiver 245, demodulated by a modulator/demodulator 246, and inputted to the control block 235. An upstream signal is modulated by the modulator/demodulator 246, converted into a transmission signal by the transmitter/receiver 245, and outputted to the connecting terminal 244.

The control block 235 can convert moving images or service information downloaded from an external server, and supply it to the signal processor 234. The control block 235 can also transmit a service request signal to an external server, in response to operation of the remote controller.

The control block 235 can also read data of a card type memory 252 attached to a connector 251. Therefore, the apparatus can take photograph image data or the like from the card type memory 252, and display the data on the display apparatus 2103. In addition, when special color control or the like is performed, the control block 235 can use image data from the card type memory 252 as standard data or reference data.

In the above apparatus, when the user wishes to view a desired program of a digital television broadcasting signal, the user controls the tuner 224 and selects the program, by operating the remote controller 2104.

The output of the tuner 224 is decoded by the decoder 225 and demodulated into a baseband image signal. The baseband image signal is inputted from the selector 226 to the signal processor 234. Thereby, the user can view the desired program on the display apparatus 2103.

When the user wishes to play back and view a stream file which is recorded on the HDD 257, the user designates display of a recording list file by operating, for example, the remote controller 2104. When the user designates display of the recording list file, a recording list is displayed as a menu. Therefore, the user moves the cursor to a position of a desired program name or a file name in the displayed list, and operates the select button. Thereby, playback of the desired stream file is started.

The designated stream file is read out from the HDD 257 under the control of the playback controller 235b, decoded by the recording and playback signal processor 255, and inputted to the signal processor 234 through the control block 235 and the selector 226.

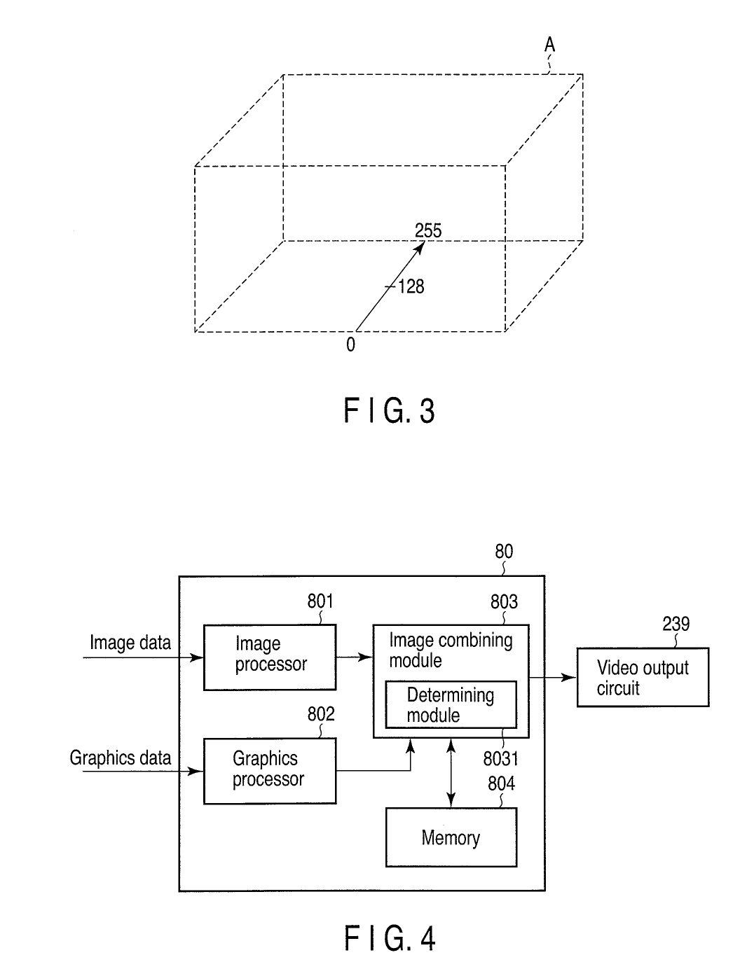

FIG. 3 is a schematic drawing illustrating a maximum display range A of a three-dimensional image which the display apparatus 2103 can display. The maximum display range A indicates a full range of the depth direction of a three-dimensional image. Although the maximum display range A differs according to the performance of the display apparatus 2103, the maximum display range A is applicable to the case where the user in the viewing area views the display apparatus 2103. In the present embodiment, the term “depth” is defined as a position from the front toward the depth direction in the maximum display range A in the depth direction of a three-dimensional image. The relative value of the front of the maximum display range A is defined as 0, and the relative value of the deepest end of the maximum display range A is defined as 255. Therefore, the depth range of the maximum display range A is 255. In the present embodiment, the size (width) in the depth direction of a three-dimensional image is defined as depth range. Although the value of the front of the maximum display range A is defined as 0, the value of the deepest end of the maximum display range A may be defined as 0. As another example, the value of the center in the maximum display range A may be defined as 0, the value of the front may be defined as 127, and the value of the deepest end may be defined as −128.

Next, the structure of the 3D processor 80 is explained. FIG. 4 is a block diagram illustrating the structure of the 3D processor 80. The 3D processor 80 includes an image processor 801, a graphics processor 802, an image combining module 803, and a memory 804. Operations of the modules will be explained hereinafter. The image processor 801 generates 3D image data from 2D image data. The image processor 801 functions as a generation module for 3D image data. Any technique can be adopted as a technique of converting 2D image data into 3D image data. The image processor 801 does not need 3D image data generating processing when the input image data is 3D image data. The image processor 801 supplies 3D image data to the image combining module 803.

The graphics processor 802 generates 3D graphics data from 2D graphics data. The graphics processor 802 functions as a generation module for 3D graphics data. Any technique can be adopted as a technique for converting 2D graphics data into 3D graphics data. The graphics processor 802 does not need 3D graphics data generating processing, when the input graphics data is 3D graphics data. The graphics processor 802 supplies 3D graphics data to the image combining module 803.

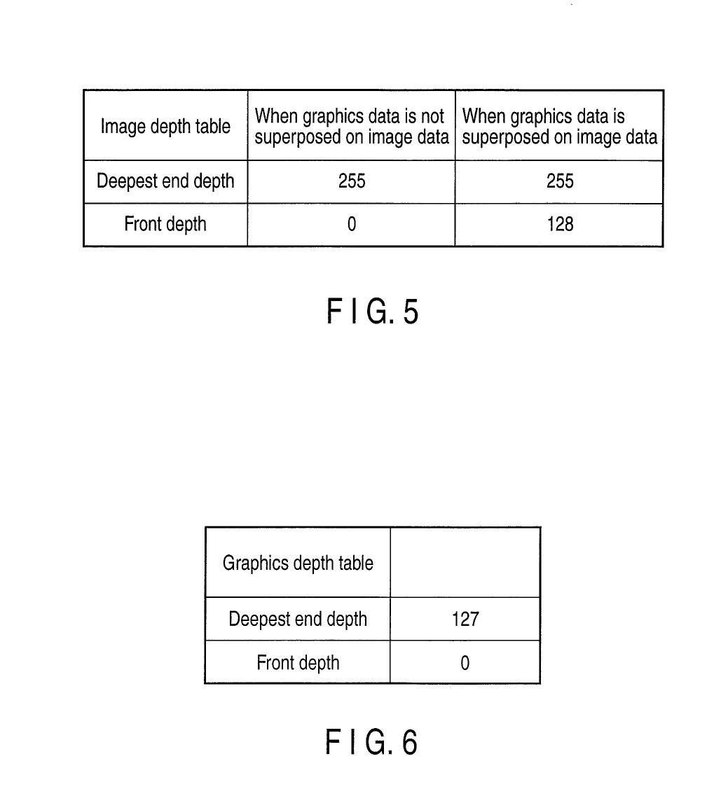

The memory 804 stores an image depth table relating to a display range of 3D image data, and a graphics depth table relating to a display range of 3D graphics data. FIG. 5 illustrates the image depth table. The image depth table stores the following setting. When 3D graphics data is not superposed on 3D image data, the display range of the 3D image data starts from the front depth 0 and extends to the deepest end depth 255. The depth range is 255. Specifically, the depth range of the 3D image data is a full range. On the other hand, when 3D graphics data is superposed on 3D image data, the display range of the 3D image data starts from the front depth 128, and extends to the deepest end depth 255. The depth range is 127. The depth range of the 3D image data is smaller than the full range. Specifically, the depth range of the 3D image data is variable according to whether 3D graphics data is superposed on 3D image data or not.

FIG. 6 illustrates the graphics depth table. When 3D graphics data is superposed on 3D image data, the display range of the 3D graphics data starts from the front depth 0, and extends to the deepest end depth 127. The depth range is 127. The depth range of the 3D graphics data is smaller than the full range. Specifically, the depth range of the 3D graphics data is changed between an on state (127) and an off state (0) according to whether 3D graphics data is superposed on 3D image data or not.

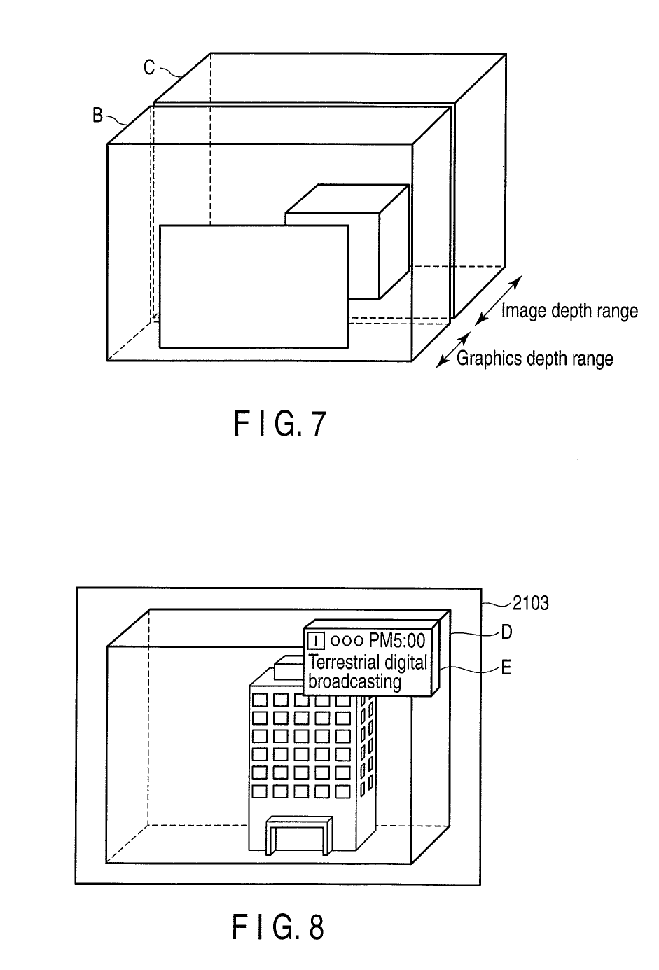

FIG. 7 is a schematic diagram in the case where 3D graphics data is superposed on 3D image data based on FIG. 5 and FIG. 6. A display range B of 3D graphics data is located in front of a display range of 3D image data in the depth direction, and does not overlap the display range C of 3D image data in the depth direction. Therefore, the display range B of 3D graphics data is a range obtained by excluding the display range C of 3D image data from the maximum display range A illustrated in FIG. 3.

The image combining module 803 processes 3D image data, with reference to the image depth table illustrated in FIG. 5. Specifically, when 3D graphics data is not superposed on 3D image data, the image combining module 803 processes the 3D image data such that the 3D image data falls within the display range having a depth range from the front depth 0 to the deepest end depth 255. The image combining module 803 functions as a processor to process the 3D image data to fall within the display range. The image combining module 803 processes the 3D image data by multiplying the depth by, for example, a constant which is obtained by “(depth range in the case where 3D graphics data is superposed on 3D image data)/(depth range in the case where 3D graphics data is not superposed on 3D image data)”. The image combining module 803 may process 3D image data, by using a depth which is more front than the front depth in the display range of 3D image data set in the image depth table as the front depth.

The image combining module 803 includes a determining module 8031 which determines whether there is 3D graphics data to be superposed on 3D image data or not (whether the graphics processor 802 generates 3D graphics data or not). The determining module 8031 determines whether there is 3D graphics data to be superposed on 3D image data, as explained hereinafter. For example, when there is 3D graphics data to be superposed on 3D image data, the graphics processor 802 transmits notification indicating it to the determining module 8031. When the determining module 8031 receives the notification data, the determining module 8031 determines that there is 3D graphics data to be superposed on 3D image data. On the other hand, when the determining module 8031 does not receive the notification data, the determining module 8031 determines that there is no 3D graphics data to be superposed on 3D image data.

As another method, the graphics processor 802 may set a flag to clearly indicate whether there is 3D graphics data to be superposed on 3D image data. In such a case, the determining module 8031 determines whether there is 3D graphics data to be superposed on 3D image data, based on the flag.

On the other hand, when 3D graphics data is superposed on 3D image data, the image combining module 803 processes 3D image data such that the 3D image data falls within the display range which has a depth range from the front depth 128 to the deepest end depth 255, with reference to the image depth table illustrated in FIG. 5. When 3D graphics data is superposed on 3D image data, the image combining module 803 processes 3D graphics data such that the 3D graphics data falls within the display range which has a depth range from the front depth 0 to the deepest end depth 255, with reference to the graphics depth table illustrated in FIG. 6. The image combining module 803 functions as a processor to make 3D graphics data fall within the display range. The image processor 801 and the graphics processor 802 may perform the same processing as the above depth range processing performed by the image combining module 803.

The image combining module 803 generates a plurality of parallactic images from the 3D image data, which has been processed to fall within the display range by processing the depth range. In the same manner, the image combining module 803 generates a plurality of parallactic images from the 3D graphics data, which has been processed to fall within the display range by processing the depth range. When the 3D graphics data is superposed on the 3D image data, the image combining module 803 combines the parallactic images of the 3D image data with the respective corresponding parallactic images of the 3D graphics data, and thereby generates a plurality of new parallactic images (hereinafter referred to as a plurality of combined parallactic images).

The image combining module 803 supplies the parallactic images of the 3D image data or the combined parallactic images to the video output circuit 239. The video output circuit 239 controls to display the parallactic images of the 3D image data or the combined parallactic images on the display apparatus 2103. The display apparatus 2103 displays a three-dimensional image, by using the parallactic images of the 3D image data, or the combined parallactic images. The display apparatus 2103 displays such that the user can view a three-dimensional image with a depth, when the user in the viewing area views the display apparatus 2103.

As described above, when 3D graphics data is not superposed on 3D image data, the image combining module 803 processes the 3D image data such that the 3D image data falls within the display range which has a depth range from the front depth 0 to the deepest end depth 255 (that is, the full range). In addition, the image combining module 803 sets the depth range of 3D graphics to 0 (off). The display apparatus 2103 displays a three-dimensional image, by using a plurality of parallactic images based on the 3D image data which is fallen within the display range of the full range.

On the other hand, as described above, when 3D graphics data is superposed on 3D image data, the image combining module 803 processes the 3D image data such that the 3D image data falls within the display range which has a depth range from the front depth 128 to the deepest end depth 255 (in other words, the 3D image data is compressed to be smaller than the full range). Besides, the image combining module 803 processes the 3D graphics data such that the 3D graphics data falls within the display range which has a depth range from the front depth 0 to the deepest end depth 127. Specifically, the image combining module 803 controls the display ranges, such that the 3D graphics data is disposed in front of the 3D image data in the depth direction and they do not overlap each other in the depth direction. The display apparatus 2103 displays a three-dimensional image, by using a plurality of combined parallactic images based on the 3D image data and the 3D graphics data which are fallen within the respective display ranges.

FIG. 8 is a schematic diagram illustrating the case where 3D graphics data is superposed on 3D image data. 3D image data D is a three-dimensional image based on content. 3D graphics data E is a three-dimensional image based on channel information. The display apparatus 2103 displays the data D and E, such that the 3D graphics data E is disposed in front of the 3D image data D in the depth direction and they do not overlap each other in the depth direction. Therefore, the user can cognize the content of the 3D graphics data E, with no influence of the 3D image data D.

According to the present embodiment, the display range of the 3D image data and the display range of the 3D graphics data, which are displayed on the display apparatus 2103, are limited not to overlap each other in the depth direction. Therefore, it is possible to prevent display of an unnatural three-dimensional image on the display apparatus 2103. In addition, since the depth range of the 3D image data is narrowed only when 3D graphics data is superposed on the 3D image data, the display apparatus 2103 can display a three-dimensional image based on 3D image data to the maximum, without deterioration of the 3D effect.

Although the present embodiment shows the case where the depth range of 3D graphics data is turned on and off and variable, the embodiment is not limited to it. For example, the depth range of the 3D image data and the depth range of the 3D graphics data in the case where the 3D graphics data is superposed on the 3D image data may be variable. The graphics depth table stores different depth ranges according to the type of the 3D graphics data. For example, when the 3D graphics data is based on the setting picture, the graphics depth table stores a setting of a display range which has a depth range that starts from the front depth 0 and extends to the deepest end depth 127. For example, when the 3D graphics data is based on an EPG picture, the graphics depth table stores a setting of a display range which has a depth range that starts from the front depth 0 and extends to the deepest end depth 50. Specifically, the depth range of 3D graphics data is set based on the user's convenience according to the type of the 3D graphics data. When the graphics data is based on the setting picture, the user performs operation on the setting picture based on intuition by using the remote controller 2104, and thus a wider depth range is desirable. On the other hand, when the graphics data is based on an EPG picture including a number of characters, it is necessary for the user to recognize the characters of the EPG picture with one's eyes, and thus a narrower depth range is desirable.

The image depth table also stores different depth ranges according to the type of 3D graphics data, when 3D graphics data is superposed on 3D image data. Specifically, the image depth table stores settings of the front depth, the deepest end depth, and the depth range, on the assumption that a range which is obtained by excluding the display range of 3D graphics data from the maximum display range is used as the display range of 3D image data. Since the depth range of 3D image data changes according to the type of the 3D graphics data, the 3D image data can be displayed with the maximum 3D effect.

As another example, the depth range of 3D image data and the depth range of 3D graphics data may be fixed, regardless of whether 3D graphics data is superposed on 3D image data or not. For example, the image depth table stores a setting of a display range which has a depth range (fixed) that starts from the front depth 128 and extends to the deepest end depth 255. For example, the graphics depth table stores a setting of a display range which has a depth range (fixed) that starts from the front depth 0 and extends to the deepest end depth 127. In such a case, the image combining module 803 does not need to process the depth range of 3D image data, regardless of whether there is 3D graphics data to be superposed on the 3D image data.

The graphics depth table may store a setting in which the front depth in the display range of 3D graphics data is a position of a projection plane. In the present embodiment, a plane in the depth direction, on which the finest image is projected when the user in the viewing area views a plane image (2D) displayed on the display apparatus 2103, is defined as the projection plane. Generally, the projection plane is a panel surface of the display apparatus 2103. The display apparatus 2103 can display a three-dimensional image with an improved readability, when 3D graphics data includes characters. Therefore, the user can view a three-dimensional image which is based on 3D graphics data and displayed on the display apparatus 2103 in a clear and less-blurred state.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a first generation module configured to generate 3D image data;
a second generation module configured to generate 3D graphics data; and
a processor configured to set the 3D image data within a first display range having a first depth range in a depth direction, and to set the 3D graphics data within a second display range having a second depth range which does not overlap the first display range in the depth direction.

2. The apparatus of claim 1 wherein the first display range is disposed in front of the second display range in the depth direction.

3. The apparatus of claim 1 wherein the first display range comprises a maximum display range, excluding the second display range.

4. The apparatus of claim 1 further comprising:
a determination module configured to determine whether the second generation module generates the 3D graphics data or not.

5. The apparatus of claim 4 wherein
the processor is configured to set the first depth range to a depth range of a maximum display range, and to set the second depth range to zero, when the determination module determines that the second generation module does not generate the 3D graphics data.

6. The apparatus of claim 1 wherein the processor is configured to control the first depth range according to a type of the 3D graphics data.

7. The apparatus of claim 1 wherein the first depth range and the second depth range are fixed.

8. The apparatus of claim 1 further comprising:
a display controller configured to control display of a plurality of parallactic images based on the 3D image data.

9. An image processing method comprising:
generating 3D image data;
generating 3D graphics data;
setting the 3D image data within a first display range having a first depth range in a depth direction; and
setting the 3D graphics data within a second display range having a second depth range that does not overlap the first display range in the depth direction.
